(19) United States
(12) Patent Application Publication
(10) Pub. No.: US 2016/0119228 A1
(43) Pub. Date: Apr. 28, 2016

(54) FORWARDING PACKETS

(71) Applicant: Hangzhou H3C Technologies Co., Ltd., Hangzhou, Zhejiang (CN)

(72) Inventor: Zhonghua GAO, Beijing (CN)

(73) Assignee: Hangzhou H3C Technologies Co., Ltd., Hangzhou (CN)

(21) Appl. No.: 14/895,192

(22) PCT Filed: Apr. 15, 2014
(86) PCT No.: PCT/CN2014/075353

§ 371 Date: Dec. 1, 2015

(30) Foreign Application Priority Data
Jun. 24, 2013 (CN) 201310255098.0

(51) Int. Cl. H04L 12/723; H04L 12/947

(52) U.S. Cl. CPC H04L 45/50; H04L 49/25

(57) ABSTRACT

A control device may allocate a global label for a switch device based on a forwarding equivalent class (FEC), and issue the global label to the switch device. Subsequently, for a packet not carrying the global label, after matching the packet not carrying the global label with the FEC, the switch device may encapsulate the global label for the packet, and forward the packet. For a packet carrying the global label, the switch device may forward the packet carrying the global label by using a global label forwarding entry.

### BACKGROUND

Packet forwarding and forwarding strategy of a traditional switch may be separated by Software Defined Networking (SDN), such as openflow. A dedicated controller may be connected with a switch through a network cable. Subsequently, packet forwarding functions (implemented by a hardware chip) and packet forwarding strategies (various software protocols) of an original switch device may be separated to different hardware devices. A controller may also control multiple openflow switches, such that a unified forwarding control side may be implemented, and a network may be effectively controlled.

### BRIEF DESCRIPTIONS OF THE DRAWINGS

FIG. 1 is a schematic diagram illustrating a structure of an openflow network, in accordance with an example of the present disclosure.

FIG. 2 is a flowchart illustrating a method for forwarding a packet, in accordance with an example of the present disclosure.

FIG. 3 is a schematic diagram illustrating a structure of a control device, in accordance with an example of the present disclosure.

FIG. 4 is a schematic diagram illustrating a structure of a switch device, in accordance with an example of the present disclosure.

FIG. 5 is a schematic diagram illustrating another structure of a control device, in accordance with an example of the present disclosure.

FIG. 6 is a schematic diagram illustrating another structure of a switch device, in accordance with an example of the present disclosure.

### DETAILED DESCRIPTIONS

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

In the prior art, the flow table may be implemented by an access control list (ACL). However, the controller needs to issue a flow table to each switch, which means that a large number of ACLs may be consumed.

Subsequently, resources may be wasted, and efficiency may be lower.

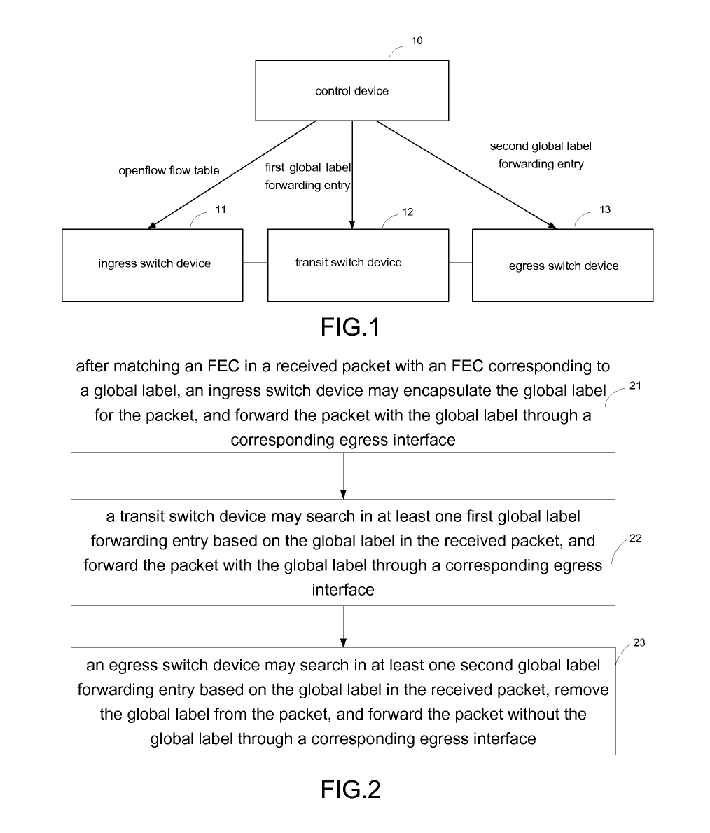

In an example of the present disclosure, switch devices at different locations of transmitting direction of a data packet may be classified into three categories, which are respectively an ingress switch device, a transit switch device and an egress switch device. Whether a switch acts as an ingress switch device, transit switch device or egress switch device depends on its location in the network and the direction of traffic flow. A given switch may be capable of acting as any of an ingress, transit or egress switch device depending on its location and the traffic flow which it is processing. Thus in some examples a switch may be capable of adopting different modes of operation depending on whether it is acting as a ingress, transit or egress switch device. FIG. 1 shows an example with an ingress switch device 11, transit switch device 12 and egress switch device 13 in which data traffic is to enter the ingress switch device 11, be forwarded by the ingress switch device 11 to the transit switch device 12, forwarded by the transit switch device 12 to the egress switch device 13 and leave via the egress switch device 13 which may forward the traffic elsewhere. In other examples there may be multiple transit switch devices 12 between the ingress switch device 11 and the egress switch device 13.

In the present disclosure, processing modes for the foregoing three kinds of switches devices may be different. In the present disclosure, a control device 10 may allocate a unified global label for switch devices based on a forwarding equivalent class (FEC), issue an openflow flow table with the global label to the ingress switch device 11, issue at least one first global label forwarding entry with the global label to the transit switch device 12, and issue at least one second global label forwarding entry with the global label to the egress switch device 13. Thus, when receiving a packet, the ingress switch device 11 may match an FEC in the packet with an FEC corresponding to the global label in the openflow flow table. After matching the FEC in the received packet with the FEC corresponding to the global label in the openflow flow table, the ingress switch device 11 may encapsulate the global label for the packet, and forward the packet encapsulated with the global label. After receiving the packet, the transit switch device 12 may search in the at least one first global label forwarding entry based on the global label in the packet, and forward the packet encapsulated with the global label. After receiving the packet, the egress switch device 13 may search in the at least one second global label forwarding entry based on the global label in the packet, remove the global label from the packet, and forward the packet without the global label. In an example of the present disclosure, a label of a multi-protocol label switching (MPLS) network may be introduced to an openflow network. The control device 10 may issue a simple label forwarding entry to the transit switch device 12 and the egress switch device 13. Since the transit switch device 12 and the egress switch device 13 do not need to match the flow table, and no longer employ the ACL rule to match flow, specifications supported by a network device and forwarding speed of the network device may be greatly improved.

Detailed descriptions about the present disclosure will be provided in the following, accompanying with specific examples. FIG. 1 is a schematic diagram illustrating a structure of an openflow network, in accordance with an example of the present disclosure. As shown in FIG. 1, a control device 10 may be respectively connected with an ingress switch device 11, a transit switch device 12 and an egress switch device 13 by respective control channels. The control device 10 may be connected directly to the switch devices, for instance using network cables as shown in FIG. 1, or may be connected indirectly via other network devices. First of all, the control device 10 issues a SDN flow table to the ingress switch device 11, issues at least one first global label forwarding entry to the transit switch device 12, and issues at least one second global label forwarding entry to the egress switch device 13. Working principle of the control device 10 will be described in detail in the following. In the following, openflow is used as an example although the present disclose may be implemented with other types of SDN.

First of all, the control device 10 may allocate a global label for the ingress switch device 11 based on an FEC, meanwhile calculate an egress interface corresponding to the ingress switch device 11. The global label refers to a unique label allocated globally, which is in a one-to-one correspondence with the FEC. The control device 10 may issue to the ingress switch device 11 an openflow flow table, which includes a corresponding relationship between an FEC and a global label, and the egress interface corresponding to the ingress switch device 11.

The FEC may be a data group, a route, an internet protocol (IP) packet five-tuple array, all the packets received by a port, or a packet carrying a certain virtual local area network (VLAN) tag, and so on. In the present disclosure, the control device may allocate different global labels to different FECs. One FEC may plan a label switched path (LSP) in the openflow network, to guide packet forwarding. That is, under the guidance of the control device, forwarding paths of packets of a same FEC are the same.

Flow table header issued by the control device 10 to the ingress switch device 11 may carry the FEC. Carrying which kind of FEC may be determined based on service requirements. For instance, in an example of the present disclosure, an IP destination address may be taken as the FEC, and a corresponding global label value is 100. A flow table executing instruction issued by the control device 10 to the ingress switch device 11 may require that, when a data packet is matched with the FEC, encapsulating the global label and forwarding the data packet at a corresponding egress interface of the ingress switch device 11.

The flow table may be a forwarding strategy of a data packet, which is configured for the ingress switch device 11 based on practical conditions and is transmitted to the ingress switch device 11. A flow table entry of the flow table may include a header, a counter and an executing instruction. The header may include an ingress interface, an Ethernet source address, an Ethernet destination address, an Ethernet type, a VLAN identifier (ID), a VLAN priority, an IP source address, an IP destination address, a transmission control protocol (TCP)/user datagram protocol (UDP) destination port and a TCP/UDP source port. In the example of the present disclosure, header contents are the IP destination address. The counter is respectively stored for each table, each data flow, each port and each queue. The executing instruction refers to a processing mode of a matched data packet, which is configured for the ingress switch device 11 by the controller. In the example of the present disclosure, the executing instruction may require to encapsulate a global label 100 and forward a data packet at a corresponding egress interface of the ingress switch device 11, when the data packet is matched with the IP destination address. That is, by combining the flow table header with the executing instruction, the corresponding relationship between the FEC and the global label may be demonstrated. There may be many modes for the control device 10 to calculate the corresponding egress interface of the ingress switch device 11. The control device 10 may calculate a corresponding egress interface of each switch device, based on topology information of the openflow network. For example, each switch device may inform the control device 10 about the topology information. And then, the control device 10 may calculate the corresponding egress interface of the ingress switch device 11, based on the obtained topology information.

It should be noted that, the control device 10 may issue the flow table to the ingress switch device 11, and the ingress switch device 11 may store the flow table. After receiving a packet by the ingress switch device 11, when no flow table is matched, that is, a corresponding FEC is not searched out (i.e. not found), the ingress switch device 11 may submit the packet to the control device 10, to trigger the control device 10 to issue the needed flow table.

Secondly, the control device 10 may allocate the global label for the transit switch device 12 based on the FEC, meanwhile calculate an egress interface corresponding to the transit switch device 12. The control device 10 may also issue to the transit switch device 12 at least one first global label forwarding entry, which includes the global label and the egress interface corresponding to the transit switch device 12.

In the example of the present disclosure, the IP destination address is taken as the FEC, and the corresponding global label value is 100. The at least one first global label forwarding entry issued by the control device 10 to the transit switch device 12 may include a global label value 100 and an egress interface. Furthermore, a first global label forwarding entry may also include a next hop. There may be many modes for the control device 10 to calculate the corresponding egress interface of the transit switch device 12. The control device 10 may calculate a corresponding egress interface of each switch device, based on topology information in the openflow network. For example, each switch device may inform the control device 10 about the topology information. The control device 10 may calculate the corresponding egress interface of the transit switch device 12, based on the obtained topology information.

There may be multiple modes for the control device 10 to issue a label forwarding entry to the transit switch device 12, which may be set by using a simple network management protocol (SNMP), a netconf, or a private mode of the switch device.

Thirdly, the control device 10 may allocate the global label for the egress switch device 13 based on the FEC, meanwhile calculate a corresponding egress interface of the egress switch device 13. The control device 10 may also issue to the egress switch device 13 at least one second global label forwarding entry, which includes the global label and the corresponding egress interface of the egress switch device 13.

In the example of the present disclosure, the IP destination address is taken as the FEC, and the corresponding global label value is 100. The at least one second global label forwarding entry issued by the control device 10 to the egress switch device 13 may include a global label value 100 and an egress interface. Furthermore, a second global label forwarding entry may also include a next hop. There may be multiple modes for the control device 10 to calculate the corresponding egress interface of the egress switch device 13. The control device 10 may calculate a corresponding egress interface of each switch device, based on the topology information of the openflow network. For example, each switch device may inform the control device 10 about the topology information. And then, the control device 10 may calculate the corresponding egress interface of the egress switch device 13, based on the obtained topology information.

There may be multiple modes for the control device 10 to issue a label forwarding entry to the egress switch device 13, which may be set by using the SNMP, the NetConf, or a private mode of the switch device.

For the same FEC, the control device 10 may issue a same global label to the ingress switch device 11, the transit switch device 12 and the egress switch device 13, so as to provide a guidance path. All of the matched data packets may be forwarded along with this guidance path. FIG. 2 is a flowchart illustrating a method for forwarding a packet, in accordance with an example of the present disclosure.

In block 21, after matching an FEC in a received packet with an FEC corresponding to a global label, an ingress switch device may encapsulate the global label for the packet, and forward the packet with the global label through a corresponding egress interface.

Specifically speaking, in the example of the present disclosure, an IP destination address is taken as the FEC, and a corresponding global label value is 100. After receiving a packet carrying the IP destination address, the ingress switch device may search in a flow table to determine whether there is a matched flow table entry, that is, whether there is a matched FEC. When searching out a matched IP destination address, the data packet with the global label value 100 may be forwarded through a corresponding egress interface of the ingress switch device.

In block 22, a transit switch device may search in at least one first global label forwarding entry based on the global label in a received packet, and forward the packet with the global label through a corresponding egress interface.

Specifically speaking, after receiving the packet with the global label value 100, the transit switch device may search in the at least one first global label forwarding entry to determine whether there is a matched label value. When searching out the matched global label value 100, the data packet with the global label value 100 may be forwarded through a corresponding egress interface of the transit switch device. Since a packet entering the transit switch device and a packet forwarded by the transit switch device may respectively carry a label, labels of the transit switch device may be divided into an in label and an out label. However, in the present disclosure, the control device may allocate a unique label in the openflow network for each FEC, that is, the global label. Subsequently, the in label and out label issued by the control device to the transit switch device are the same, both of which are referred to as the global label.

In block 23, an egress switch device may search in at least one second global label forwarding entry based on the global label in a received packet, remove the global label from the packet, and forward the packet without the global label through a corresponding egress interface.

Specifically speaking, after receiving a packet carrying the global label value 100, the egress switch device may search in the at least one second global label forwarding entry for a matched label value. When searching out the matched global label value 100, the egress switch device may remove the global label from the packet, and forward the packet without the global label through a corresponding egress interface of the egress switch device.

Until now, the packet forwarding method provided by the present disclosure may be completed. It should be noted that, the “first” and “second” respectively in foregoing first global label forwarding entry and second global label forwarding entry are configured to distinguish whether the label forwarding entry is issued to the transit switch device or the egress switch device. Thus, the foregoing “first” and “second” are relative definitions. The first global label forwarding entry and the second global label forwarding entry both include the global label and a next hop.

In addition, when one control device manages many services, the conditions of inadequate label may occur. Thus, in the example of the present disclosure, when a control device has a large capacity, the problem of inadequate label may be solved by employing a two-layer label. Specifically speaking, an outer label and an inner label may be combined to form a global label, which may be carried by a flow table. Thus, a flow table may be uniquely determined. Alternatively, the global label may be carried by a global label forwarding entry, so as to uniquely determine a forwarding entry. The outer label may be allocated by a network administrator, and the inner label may be allocated by the control device. For example, label space range is 1-100, outer label value may be 1-100, and inner label value may also be 1-100. Thus, there may be 100*100=10000 values of the global label. Compared with a single-layer label of 100 values, the problem of inadequate label may be effectively solved.

In the present disclosure, after the control device implements the management of global label space of the openflow network, the following advantages may be brought.

1) The complexity for the control device to allocate a label may be reduced. In the whole network, an FEC and a label are in a one-to-one correspondence.

2) Network management may be facilitated, and a unique label in the openflow network may be employed to uniquely identify a service flow.

3) Implementation of a multicast service may be facilitated, and a ring network protection may also be facilitated.

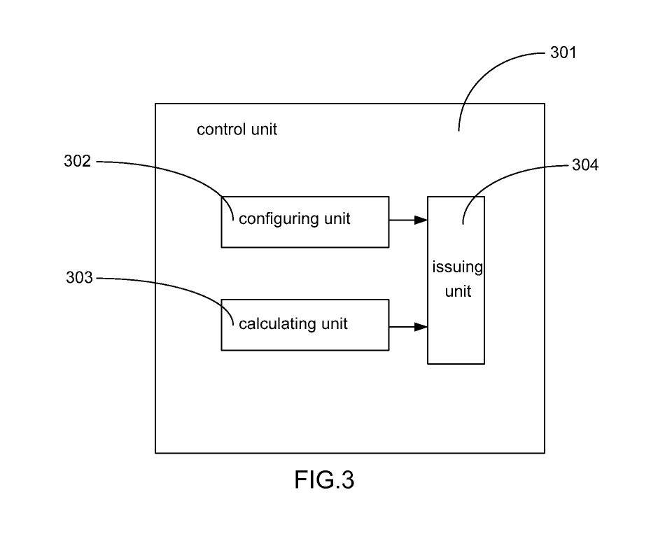

An example of the present disclosure also provides a control device, which may be applied in an openflow network including the control device and a switch device. With reference to FIG. 3, FIG. 3 is a schematic diagram illustrating a structure of a control device, which applies the foregoing method, in accordance with an example of the present disclosure. The control device may include a control unit 301.

The control unit 301 is configured to allocate a unified global label based on an FEC, and issue the global label to the switch device. Subsequently, after matching a packet not carrying the global label with the FEC, the switch device may encapsulate the global label for the packet, and forward the packet. For a packet carrying the global label, the switch device may forward the packet, by using a global label forwarding entry.

Furthermore, the control unit 301 may include a configuring unit 302, a calculating unit 303 and an issuing unit 304.

The configuring unit 302 is configured to allocate a unified global label for the switch device based on the FEC.

The calculating unit 303 is configured to calculate a corresponding egress interface of the switch device.

The issuing unit 304 is configured to issue to an ingress switch device an openflow flow table, which includes a corresponding relationship between an FEC and a global label, as well as a corresponding egress interface of the ingress switch device. Subsequently, after matching an FEC in a received packet with an FEC corresponding to the global label, the ingress switch device may encapsulate the global label for the packet, and forward the packet with the global label through the corresponding egress interface. The issuing unit 304 is further configured to issue to a transit switch device at least one first global label forwarding entry, which includes the global label and a corresponding egress interface of the transit switch device. Subsequently, the transit switch device may search in the at least one first global label forwarding entry, based on the global label in the received packet, and forward the packet with the global label through the corresponding egress interface. The issuing unit 304 is further configured to issue to an egress switch device at least one second global label forwarding entry, which includes the global label and a corresponding egress interface of the egress switch device. Subsequently, the egress switch device may search in the at least one second global label forwarding entry based on the global label in the received packet, remove the global label from the packet, and forward the packet without the global label through the corresponding egress interface.

In the foregoing example, the control device may allocate a unified global label for the switch device based on the FEC, and issue the global label to the switch device. Subsequently, after matching a packet not carrying the global label with the FEC, the switch device may encapsulate the global label for the packet, and forward the packet. For a packet carrying the global label, the switch device may forward the packet, by using a global label forwarding entry. Compared with technologies in the prior art, that is, each switch device needs to match with a flow table, since ACL rule is no longer used to match with a flow, specifications supported by a network device and forwarding speed of the network device may be greatly improved.

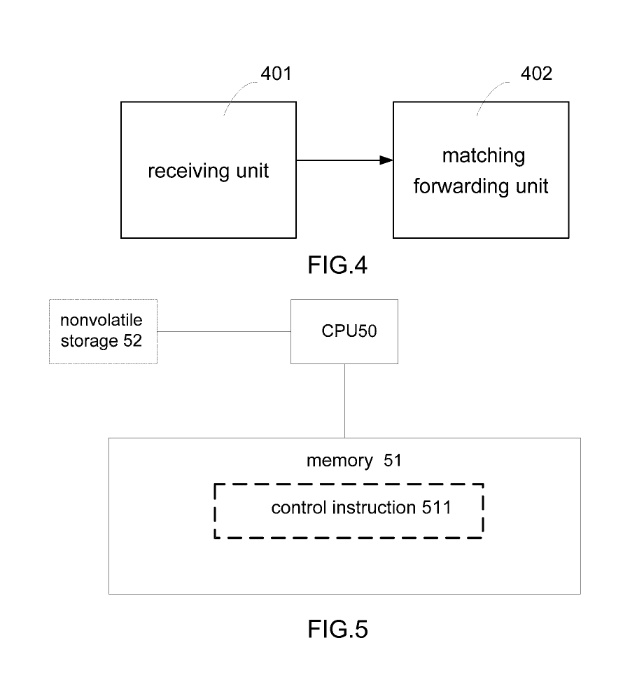

An example of the present disclosure also provides a switch device, which may be applied in an openflow network including a control device and the switch device. With reference to FIG. 4, FIG. 4 is a schematic diagram illustrating a structure of a switch device, which may apply the foregoing method, in accordance with an example of the present disclosure. The switch device may be taken as any one of an ingress switch device, a transit switch device and an egress switch device.

When the switch device is taken as the ingress switch device, the switch device may include a receiving unit 401 and a matching forwarding unit 402.

The receiving unit 401 is configured to receive from the control device an openflow flow table, which includes a corresponding relationship between an FEC and a global label, as well as a corresponding egress interface of the ingress switch device.

After matching an FEC in a received packet with an FEC corresponding to a global label, the matching forwarding unit 402 is configured to encapsulate the global label for the packet, and forward the packet with the global label through the corresponding egress interface.

When the switch device is taken as the transit switch device, the receiving unit 401 is configured to receive from the control device at least one first global label forwarding entry, which includes a global label and a corresponding egress interface of the transit switch device.

The matching forwarding unit 402 is configured to search in the at least one first global label forwarding entry, based on the global label in the received packet, and forward the packet with the global label through the corresponding egress interface.

When the switch device is taken as the egress switch device, the receiving unit 401 is configured to receive from the control device at least one second global label forwarding entry, which includes a global label and a corresponding egress interface of the egress switch device.

The matching forwarding unit 402 is configured to search in the at least one second global label forwarding entry, based on the global label in the received packet, remove the global label from the packet, and forward the packet without the global label through the corresponding egress interface.

FIG. 5 is a schematic diagram illustrating another structure of a control device, which may apply the foregoing method, in accordance with an example of the present disclosure. As shown in FIG. 5, the control device may include a central processing unit (CPU) 50, a memory 51.

The memory 51 may store computer executable instructions, which may be executable by the CPU 50. The foregoing computer executable instructions may include a control instruction 511.

The control instruction 511 may indicate to allocate a unified global label based on an FEC, and issue the global label to a switch device. Subsequently, after matching a packet not carrying the global label with the FEC, the switch device may encapsulate the global label for the packet, and forward the packet. For a packet carrying the global label, the switch device may forward the packet by using a global label forwarding entry.

The control instruction 511 may further include a configuring instruction, a calculating instruction and an issuing instruction (not shown in the figure).

The configuring instruction indicates to allocate a unified global label for the switch device based on the FEC.

The calculating instruction indicates to calculate a corresponding egress interface of the switch device.

The issuing instruction indicates to issue to an ingress switch device an openflow flow table, which includes a corresponding relationship between an FEC and a global label, and a corresponding egress interface of the ingress switch device. Subsequently, after matching an FEC in a received packet with the FEC corresponding to the global label, the ingress switch device may encapsulate the global label for the packet, and forward the packet with the global label through the corresponding egress interface. The issuing instruction further indicates to issue to a transit switch device at least one first global label forwarding entry, which includes the global label and a corresponding egress interface of the transit switch device. Subsequently, the transit switch device may search in the at least one first global label forwarding entry, based on the global label in the received packet, and forward the packet with the global label through the corresponding egress interface. The issuing instruction further indicates to issue to an egress switch device at least one second global label forwarding entry, which includes the global label and a corresponding egress interface of the egress switch device. Subsequently, the egress switch device may search in the at least one second global label forwarding entry, based on the global label in the received packet, remove the global label from the packet, and forward the packet without the global label through the corresponding egress interface.

The control device shown in FIG. 5 may further include a non-transitory machine readable storage medium 52. The non-transitory machine readable storage medium 52 may store the same computer executable instructions (not shown in the figure) as stored in the memory 51. When the memory 51 is down, the computer executable instructions stored in the non-transitory machine readable storage medium 52 may be read and executed by the CPU 50.

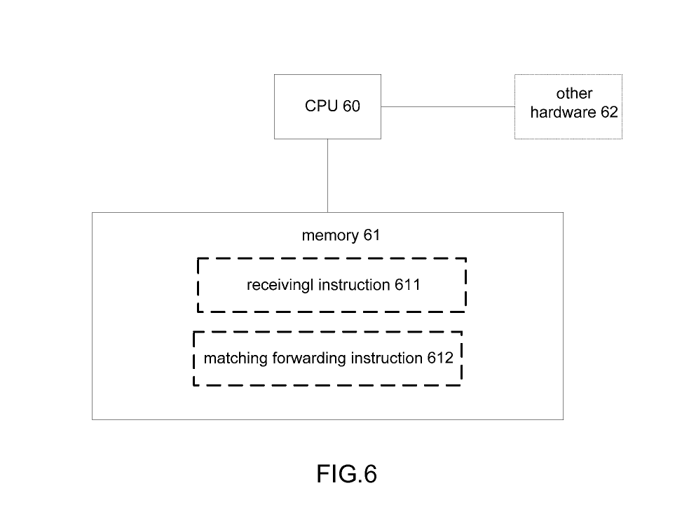

An example of the present disclosure also provides a switch device, which may be applied in an openflow network including a control device and the switch device. With reference to FIG. 6, FIG. 6 is a schematic diagram illustrating a structure of a switch device, which may apply the foregoing method, in accordance with an example of the present disclosure. The switch device may include a CPU 60 and a memory 61.

The memory 61 may store computer executable instructions, which may be executable by the CPU 60. The foregoing computer executable instructions may include a receiving instruction 611 and a matching forwarding instruction 612. The switch device shown in FIG. 6 may be taken as any one of an ingress switch device, a transit switch device and an egress switch device.

When the switch device shown in FIG. 6 is taken as the ingress switch device, the receiving instruction 611 indicates to receive from the control device an openflow flow table, which includes a corresponding relationship between an FEC and a global label, and a corresponding egress interface of the ingress switch device.

The matching forwarding instruction 612 may indicate to match the FEC in the received packet with the FEC corresponding to the global label, encapsulate the global label for the packet, and forward the packet with the global label through the corresponding egress interface.

When the switch device shown in FIG. 6 is taken as the transit switch device, the receiving instruction 611 may indicate to receive from the control device at least one first global label forwarding entry, which includes the global label and a corresponding egress interface of the transit switch device.

The matching forwarding instruction 612 may indicate to search in the at least one first global label forwarding entry, based on the global label in the received packet, and forward the packet with the global label through the corresponding egress interface.

When the switch device shown in FIG. 6 is taken as the egress switch device, the receiving instruction 611 indicates to receive from the control device at least one second global label forwarding entry, which includes the global label and a corresponding egress interface of the egress switch device.

The matching forwarding instruction 612 may indicate to search in the at least one second global label forwarding entry, based on the global label in the received packet, remove the global label from the packet, and forward the packet without the global label through the corresponding egress interface.

The switch device shown in FIG. 6 may also include other hardware 62. The other hardware 62 may also store the same computer executable instructions (not shown in the figure) as stored in the memory 61. As another implementation mode, the CPU 60 may directly read and execute the computer executable instructions stored in the other hardware 62.

In view of above, in the examples of the present disclosure, the control device may issue the openflow flow table to the ingress switch device, and issue simple label forwarding entries to the transit switch device and the egress switch device, which is not like technologies in the prior art, that is, issuing a flow table to all the switch devices. Subsequently, it is not necessary for all the switch devices to match a flow table when forwarding a packet. Thus, packet forwarding speed may be improved. Besides, in the present disclosure, the control device may issue to the switch device global labels distinguished by FEC, and plan an LSP in the openflow network based on the FEC, so as to simply network management.

1. A method for forwarding a packet, which is applied to an openflow network comprising a control device and a switch device, comprising:
allocating, by the control device, a global label for the switch device based on a forwarding equivalent class (FEC);
issuing, by the control device, the global label to the switch device, such that for a packet not carrying the global label, after matching the packet not carrying the global label with the FEC, the switch device encapsulates the global label for the packet, and forwards the packet; for a packet carrying the global label, the switch device forwards the packet with the global label by using a global label forwarding entry.

2. The method according to claim 1, wherein the switch device is an ingress switch device and
the control device allocates the global label for the ingress switch device based on the FEC, and calculates a corresponding egress interface of the ingress switch device;
and the control device issues a flow table to the ingress switch device, the flow table comprising a corresponding relationship between an FEC and a global label, as well as the corresponding egress interface of the ingress switch device, such that after matching the FEC in the received packet with the global label, the flow table causes the ingress switch device to encapsulate the global label for the packet, and forward the packet with the global label through the corresponding egress interface.

3. The method according to claim 1, wherein the switch device is a transit switch device, and
the control device allocates the global label for the transit switch device based on the FEC, and calculates a corresponding egress interface of the transit switch device;
and the control device issues at least one first global label forwarding entry to the transit switch device, the flow table comprising the global label and the corresponding egress interface of the transit switch device, such that the transit switch device searches in the at least one first global label forwarding entry based on the global label in the received packet, and forwards the packet with the global label through the corresponding egress interface.

4. The method according to claim 1, wherein the switch device is an egress switch device, and
the control device allocates the global label for the egress switch device based on the FEC, and calculates a corresponding egress interface of the egress switch device;
and the control device issues at least one second global label forwarding entry to the egress switch device, the at least one second global label forwarding entry comprising the global label and the corresponding egress interface of the egress switch device, such that the egress switch device searches in the at least one second global label forwarding entry based on the global label in the received packet, removes the global label from the packet, and forwards the packet without the global label through the corresponding egress interface.

5. The method according to claim 1, wherein the global label comprises an outer label and an inner label.

6. A control device for a Software Defined Network (SDN) comprising a processor and a memory,
the memory is to store machine readable instructions executable by the processor to: allocate a global label for a switch device based on a forwarding equivalent class (FEC), and issue the global label to the switch device, such that for a packet not carrying the global label, after matching the packet not carrying the global label with the FEC, the switch device encapsulates the global label for the packet, and forwards the packets; and for a packet carrying the global label, the switch device forwards the packet carrying the global label by using a global label forwarding entry.

7. The control device according to claim 6, wherein the SDN includes an ingress switch device, a transit switch device and an egress switch device, and the machine readable instructions are further to calculate a corresponding egress interface of the switch device and
issue to an ingress switch device a flow table, which comprises a corresponding relationship between an FEC and a global label, as well as a corresponding egress interface of the ingress switch device, such that after matching the FEC in the received packet with the FEC corresponding to the global label, the flow table causes the ingress switch device to encapsulate the global label for the packet, and forward the packet with the global label through the corresponding egress interface;
the machine readable instructions are further to issue to the transit switch device at least one first global label forwarding entry, which comprises the global label and a corresponding egress interface of the transit switch device, such that the transit switch device searches in the at least one first global label forwarding entry based on the global label in the received packet, and forwards the packet with the global label through the corresponding egress interface;
the machine readable instructions are further to issue to the egress switch device at least one second global label forwarding entry, which comprises the global label and a corresponding egress interface of the egress switch device, such that the egress switch device searches in the at least one second global label forwarding entry based on the global label in the received packet, removes the global label from the packet, and forwards the packet without the global label through the corresponding egress interface.

8. A switch device capable of acting as an ingress switch device in a Software Defined Network (SDN), the switch device comprising a processor and a memory, the processor is to execute instructions stored in the memory to: receive from a control device a flow table, which comprises a corresponding relationship between a forwarding equivalent class (FEC) and a global label, as well as a corresponding egress interface of the ingress switch device, and after matching an FEC in a received packet with the FEC corresponding to the global label, the instructions are further to encapsulate the global label for the packet, and forward the packet with the global label through the corresponding egress interface.

9. (canceled)

10. (canceled)
